(19) United States
(12) Patent Application Publication
(10) Pub. No.: US 2007/0042335 A1
(43) Pub. Date: Feb. 22, 2007

(54) System and method for assessment or survey response collection using a remote, digitally recording user input device

(75) Inventors: Sylvia Tidwell-Scheuring, Carmel, CA (US); Robert C. Sykes, Salinas, CA (US); Theresa A. Sage, Monterey, CA (US); G. Scott Winner, Palm Springs, CA (US); Tony Flores, Monterey, CA (US); Karen Burkhart, San Diego, CA (US); Maureen E. Grazioli, Belmont, CA (US); Mostafa Mehrabani, West Harrison, NY (US)

Correspondence Address: ROTHWELL, FIGG, ERNST & MANBECK, P.C., 1425 K STREET, N.W., SUITE 800, WASHINGTON, DC, 20005, US

(73) Assignee: CTB McGraw-Hill, Monterey, CA (US)

(21) Appl. No.: 11/431,605

(22) Filed: May 11, 2006

Related U.S. Application Data
(60) Provisional application No. 60/679,656, filed on May 11, 2005.
(60) Provisional application No. 60/690,095, filed on Jun. 14, 2005.

(51) Int. Cl. G09B 3/00

(52) U.S. Cl. 434/350

(57) ABSTRACT

A system and method for collecting responses to assessment or survey items utilizes an input device to store individual responses to items of an assessment or a survey. The input device transmits the individual responses to a receiving unit for storage and analysis. The responses can be transmitted immediately upon completion of an assessment or survey item, at predetermined times during the collection of responses, after a predetermined period of user inactivity or upon completion of a predetermined group of assessment or survey items. The input device can also store a collection file containing all the responses and transmit the collection file after completion of the assessment or survey. The system and method can also utilize a locating device to determine an initial location of an input device and to monitor the current location of the input device during completion of the assessment or survey to detect and deter cheating. If the input device is found to have moved more than a predetermined acceptable distance, a notification can be sent to the user or an entity responsible for administering the assessment or survey.

This application claims the benefit of U.S. Provisional Application Ser. No. 60/679,656 filed May 11, 2005, and U.S. Provisional Application Ser. No. 60/690,095 filed Jun. 14, 2005, the contents of which are hereby incorporated by reference.

### BACKGROUND OF THE INVENTION

1. Field of the Invention

The present invention relates generally to a system and method for assessment or survey response collection using a remote, digitally recording user input device.

2. Description of the Background Art

Existing automated educational assessment or survey response capture technologies have several limitations related to the media used. Paper-and-pencil media requires collecting and optically scanning paper, which contains responses to assessment or survey items. Further, a response time for answering each item cannot be determined. If more than one response is made to a multiple choice item, the last response made, which presumably represents the assessment or survey taker's final answer choice, cannot be determined. Common practice with existing Optical Mark Read (OMR) scanning technology is to assume that a multiple choice response that is significantly darker than other marked responses is the final answer choice. While generally reliable, this technique depends upon assessment or survey takers to follow defined erasure and marking procedures. Consequently, this technique can be error-prone and unreliable.

Further, when assessments or tests are administered in a paper-and-pencil format, every assessment taker is presented with the same set of test items. Typically, most assessment takers are administered at least some items that are either very easy or very difficult. Items that are either very easy or very difficult provide little information about the assessment taker's ability level, and reduce the precision of measurement values based on the administration of the assessment.

In addition, it is costly and time consuming to prepare, administer and evaluate assessments using paper-and-pencil media. The preparation, administration and evaluation of an assessment consists of, for example, selecting one or more assessment items to be presented to assessment takers, printing the selected assessment items to create an assessment document, preparing a written or marked response to each item contained in the assessment document, collecting and optically scanning the completed assessment document, scoring each response item for each assessment taker, reviewing and reporting the scores for each assessment taker, etc.

While online assessment or survey response collections avoid the above problems, they also have limitations due to the relatively high cost of computers, especially on a per student ratio. Many schools do not have adequate funding to accomplish one-to-one computing where each student has access to his or her own computer. Moreover, there are many schools that have only one computer, which may not have internet access to accommodate online testing, in the classroom. Consequently, accessibility issues arise for many students and reduce the impact of online testing, thereby limiting the opportunity to differentiate instruction to each student's specific learning needs consistently throughout the school year.

Thus, a need exists in the art for a system and method that overcome the above deficiencies of the prior art.

### SUMMARY OF THE INVENTION

The present invention provides such a desired system and method. In one aspect, the present invention provides a system for assessment or survey response collection. The system includes an input device that has a first memory for storing an individual response to an item of an assessment or a survey, and a collection file containing all the responses to the items contained in the assessment or survey. The system further includes a receiving unit that has a second memory. The input device transmits the individual responses and, optionally, the collection file, to the receiving unit. The individual responses can be transmitted immediately upon completion of the assessment or survey item, at predetermined times during administration of the assessment or survey, after a predetermined period of user inactivity, or upon completion of a predetermined group of assessment or survey items. The receiving unit stores the transmitted individual responses in the second memory. The receiving unit of the system can also include a processor configured to analyze the assessment or survey responses transmitted from the input device, e.g. by comparing the transmitted responses against the collection file for purposes of validation. In one embodiment, the system is configured to resolve discrepancies between transmitted responses and the collection file by application of predetermined rules. In a further embodiment, the receiving unit is configured to transmit a notification to the input device or an administrator during administration of the assessment or survey.

In another aspect, the present invention provides a method of gathering a collection of assessment or survey responses using a digitally recording input device. The method includes the step of collecting individual responses to items of an assessment or a survey, and a collection file containing all the responses to the items contained in the assessment or survey. The method further includes transmitting individual responses and, optionally, the collection file, to a receiving unit remote from the input device. The individual responses are then analyzed, e.g. by comparing them against the collection file for purposes of validation. In various embodiments of the method, the individual responses can be transmitted immediately upon completion of the assessment or survey item, at predetermined times during administration of the assessment or survey, after a predetermined period of user inactivity, or upon completion of a predetermined group of assessment or survey items. In one embodiment, the method further includes the step of resolving a discrepancy between a transmitted response and the collection file that is discovered as a result of the analysis.

In yet another aspect, the present invention provides a method of collecting responses to items of an assessment or survey using a digitally recording device. The method includes the steps of associating an input device with a user and determining an initial location of the input device. The input device is then used to collect responses to items of an assessment or survey, and the responses are transmitted from the input device to a receiving unit for analysis. During the step of collecting responses, the current location of the input device is monitored, and a determination is made whether the input device has moved more than a predetermined acceptable distance based on the initial and current positions. In one embodiment of the method, a proctor administering the assessment or survey is notified if it is determined that the input device has moved more than the predetermined acceptable distance. In another embodiment of the method, the user is alerted if it is determined that the input device has moved more than the predetermined acceptable distance.

In still another aspect, the present invention provides an input device for remote collection of responses to items of an assessment or survey calling for specific response types. The device includes a user interface configured to facilitate entry of the specific response types called for by the assessment or survey items. The device also includes a processor programmed to cause responses to assessment or survey items to be stored in memory, displayed on a display unit and transmitted to a remote receiver. The device is further provided with a locating device and the processor is programmed to obtain an initial location for the input device and to monitor the input device location using the locating device to detect and deter cheating.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a flow chart illustrating a methodology of gathering an assessment or survey response collection using a digitally recording user input device according to the present invention.

FIG. 2 shows a process that illustrates the basic flow of events that occur when a current location of the input device is determined.

FIG. 3 shows a process that illustrates the basic flow of events that occur when information is collected during real-time.

FIG. 4 is a flow chart illustrating the basic flow of events that occur during a look-up process.

FIG. 5 shows a process that illustrates the basic flow of events that occur when a user is notified.

FIG. 6 is a functional block diagram of the architecture for a system and method according to the present invention.

FIG. 7 is an illustration of the front of the user input device according to a first embodiment.

FIG. 8 is an illustration of the back of the user input device according to the first embodiment.

FIG. 9 is an illustration of the front of the user input device according to a second embodiment.

FIG. 10 is an illustration of the back of the user input device according to the second embodiment.

### DETAILED DESCRIPTION OF THE PREFERRED EMBODIMENTS

In the following description, for purposes of explanation and not limitation, specific details are set forth, such as communication networks, computers, terminals, devices, components, techniques, software products and systems, operating systems, hardware, etc. in order to provide a thorough understanding of the present invention. However, it will be apparent to one skilled in the art that the present invention may be practiced in other embodiments that depart from these specific details. Detailed descriptions of well-known communication networks, computers, terminals, devices, components, techniques, software products and systems, operating systems, and hardware are omitted so as not to obscure the description of the present invention.

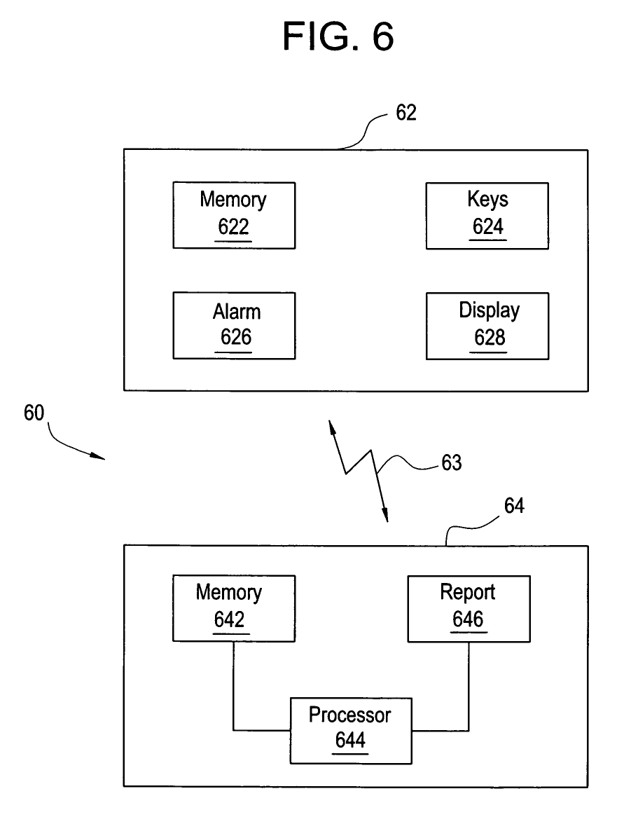

FIG. 6 is an illustration of a functional block diagram for a system and method for assessment or survey response collection according to the present invention. Referring to FIG. 6, the system 60 comprises an input device 62 for a respondent to enter responses to assessment or survey items and a receiving unit 64 for an administrator of the assessment or survey to collect responses from one or more input devices. Preferably, the input device 62 is remote from the receiving unit 64, and both the input device and the receiving unit are configured to communicate with one another remotely via a data link or connection 63. Although a wireless connection 63 is preferred, it will be appreciated that the input device 62 and receiving unit 64 can be configured to communicate via a wired connection or a combination of wired and wireless connections, e.g., if it is necessary to connect the receiving unit to a wireless router.

Referring still to FIG. 6, the input device 62 is preferably a digitally recording device that captures responses written with or entered on the input device 62. In the context of the present disclosure, the term “written” refers to any letter, symbol, number, graphic element, mark, etc., written or drawn by hand. The input device 62 generally includes a user interface 624 for generating responses to items of an assessment or survey, a display 628, and a memory 622. Also shown is an optional alarm or other audible device 626. The input device 62 is configured such that responses written with or entered using the user interface 624 are caused to be stored in memory 622, displayed on display 628 and/or transmitted to a receiving unit 64, e.g., by execution of a set of instructions by a central processing unit (CPU) as is well known in the art. The input device 64 may, e.g., be an electronic stylus, a handheld device, such as, for example, a lap top, Palm device, PDA, pager, cell phone, etc., or any device that captures responses written with or entered on the device and is capable of transmitting information to the receiving unit 64 using, for example, wireless radio frequency (RF) technology, infrared technology, etc., either directly or indirectly via a communication network.

The user interface 624 of the input device 64 can include any type of human-machine interface operable by a user to indicate a response of the type called for by an item of an assessment or survey including, without limitation, buttons or keys, a touchscreen, an electronic stylus for use with or without a digitizing tablet, a camera, a microphone, and combinations thereof. For example, if the assessment or survey item is in the form of a multiple choice question, the input device 62 can be configured with keys 624 corresponding to the available choices so that responses can be entered on the input device 62 using the input keys 624.

The input device memory 622 is used to store information such as, for example, the written or entered responses. The memory 622 can be a volatile or persistent memory or some combination of both. Examples of suitable memory include EPROMs, DIMMs, flash memory, and magnetic hard drives, although any type of suitable memory can be used.

The input device display 628 can be any type of display commonly used in a handheld or portable device including, without limitation, an LCD, LED or liquid plasma display. If the display is made up of pixels, the number, arrangement, and size of the pixels are chosen so as to effectively communicate to the respondent the type of information chosen for display.

The optional audible device 626 shown in FIG. 6 provides a mechanism for the system to provide feedback or otherwise notify the respondent. For example, as described in greater detail below, the input device 62 can be configured to sound an alarm when the system detects that the input device has been moved outside a predetermined acceptable range.

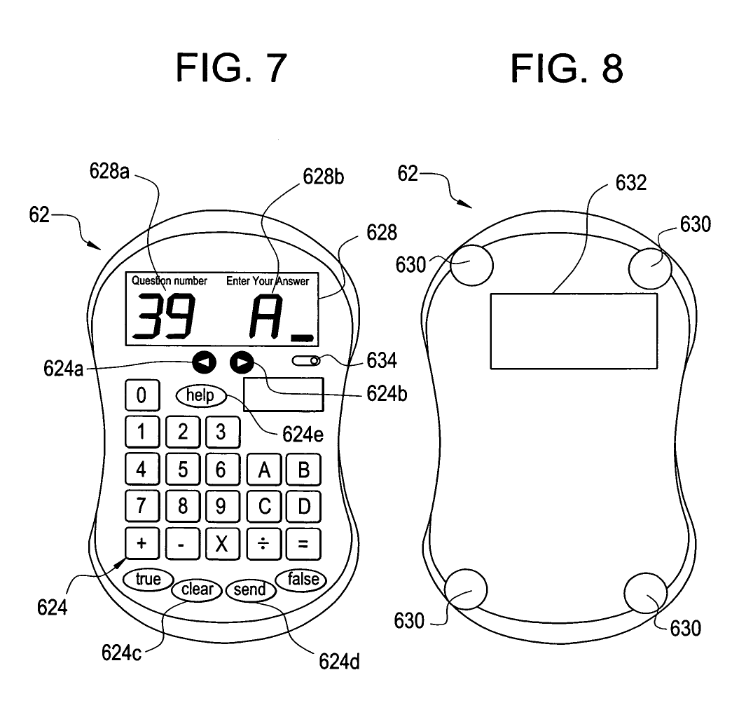

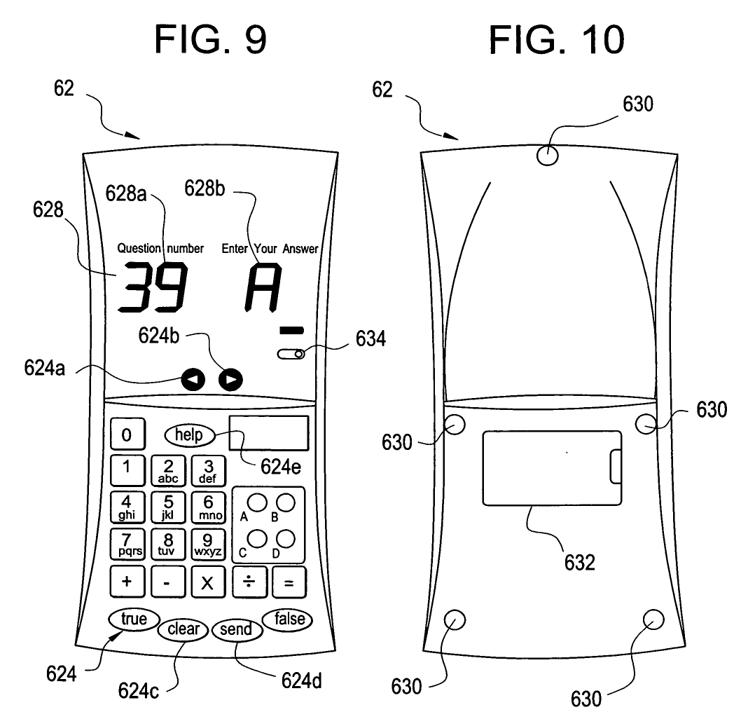

Referring now to FIGS. 7-10, physical embodiments of an input device 62 are shown that can be used, for example, in conjunction with printed assessment or survey materials containing assessment or survey items for which the respondent is expected to provide responses. More specifically, FIG. 7 shows the front of input device 62 according to a first embodiment, FIG. 8 shows the back of the input device 62 according to the first embodiment, FIG. 9 shows the front of the input device 62 according to a second embodiment, and FIG. 10 shows the back of the user input device according to the second embodiment.

In the first embodiment, shown in FIGS. 7 and 8, the input device 62 is shown with a user interface 624 comprised of response keys corresponding to the types of responses expected in connection with items contained in assessment or survey materials, in this case the letters “A”, “B”, “C” and “D”, the numbers “0” through “9”, “true” and “false”, and the arithmetic operators “+”, “−”, “×”, “÷” and “=”. Also shown are several keys to perform special functions such as scroll keys 624a, 624b to move forward or backward from one response to a successive or prior response, respectively, a clear key 624c to clear the display, a send key 624d to enter or submit a response and a help key 624e to summon an administrator. The display 628 in this embodiment is capable of displaying a single row of characters, specifically a particular item number 628a and the alphanumeric response 628b entered by the respondent.

In the embodiment shown in FIGS. 7 and 8, the display 628 is located along a top edge of the device, and the true/false, clear and send buttons are arrayed along a bottom edge of the device with the scroll keys being located immediately beneath the display and the alphanumeric response keys being located between the scroll keys and the true/false buttons. It should also be noted that the shape of the keys is differentiated to help the respondent avoid the mistake of choosing an incorrect key, with alphanumeric response keys being square in shape, true/false keys being oval in shape, scroll keys being circular, and special function keys also being oval, although other key assignments and shapes could be used.

The device 62 shown in FIGS. 7 and 8 is preferably of a size allowing the device to be handheld, with pads 630 on the back of the device to facilitate placement of the device on a desktop or table if desired. The peripheral edges of the device are curved, with top and bottom edges having a convex curvature and side edges having a concave curvature to produce a rounded, peanut-like appearance with no sharp edges. An optional battery compartment on the back of the device is accessible via a removable cover 632 to insert batteries to power the device. Alternatively, the device can be powered by a solar cell located on the front of the device, an A/C power adapter, or some combination or batteries, solar cells and/or A/C power. A power switch 634 on the front of the device is operable to allow the respondent to turn the device on and off. Although the power switch 634 is shown as a sliding switch, it will be appreciated that the switch can be configured as a button, a toggle switch, a rocker switch or any other type of switch.

The second embodiment of an input device 62 according to the present invention, shown in FIGS. 9 and 10, is similar to the first embodiment shown in FIGS. 7 and 8, but is slightly more elongate, with distinct corners and less curvature along the top and bottom edges of the device. The device in FIGS. 9 and 10 also differs in that letters are also assigned to the numeric keys, e.g., like a telephone keypad, so that responses can contain a full range of letters and words. It should also be noted that while the layout of the keys is similar to that shown in FIGS. 7 and 8, the multiple choice keys corresponding to a “A”, “B”, “C” and “D” response have a circular as opposed to square shape.

In the preferred embodiment, the responses are stored each time an answer is written with or entered on the input device 62. The user indicates when the response to the item is complete. For example, if the input device 62 is as shown in FIGS. 7-10, the user can press the send key 624d to indicate that the response is complete. Alternatively, if the input device 62 includes a touchscreen display responsive to a stylus, the user can tap (e.g., pressing downwardly) the electronic stylus a predetermined number of times (e.g., twice or three times), select an “enter” key on the input device, or the like. In an alternate embodiment, the responses can be automatically stored after a predetermined time period (e.g., every 1 minute, every 3 minutes, every 5 minutes, etc.), after a delay greater than a predetermined time period, after the completion of a particular section of the assessment or survey, or any reasonable time period that will prevent loss of information that was not stored.

The individual responses to the assessment or survey items remain in the memory 622. After the completion of the assessment or survey, a collection of responses (e.g., all the responses to the assessment/survey items contained in the assessment/survey) is also saved as a single file in the memory 622. The user can indicate that he/she has completed the assessment or survey by selecting a desired input key 624, tapping the electronic stylus 62 a predetermined number of times (e.g., four or five times), which is different from the number of times that indicates the completion of a single assessment or survey item, holding the stylus 62 horizontally for a predetermined time period (e.g., four or five seconds), etc.

In an implementation described herein and as shown in FIG. 6, the receiving unit 64 includes a memory 642 and a processor 644. It will be appreciated by those skilled in the art that the receiving unit can be separate from the processor. The processor 644 processes and analyzes the information received from the input device 62. The receiving unit 64 can also include a reporting unit 646 for reporting the processed and analyzed information. The receiving unit 64 can be any computing device capable of receiving the information transmitted from the input device 62. In an alternate embodiment, the receiving unit 64 can be a receiver that receives radio frequency signals from a transmitter/input device.

After a response (or group of responses) is stored in the memory 622 of the input device 62, the information is “transmitted” to the receiving unit 64. In another embodiment, the individual response or group of responses can be sent to the receiving unit 64 prior to the information being stored in the memory 622 of the input device 62 (but after the user indicates the response to the item is complete). In addition, the collection of responses (e.g., a single file containing all the responses to the items of the completed assessment or survey) can also be “transmitted” to the receiving unit 64.

In the exemplary embodiment, the information transmitted to the receiving unit 64 is stored in the memory 642. The stored information is then processed via the processor 644. In an alternate embodiment, the information transmitted to the receiving unit 64 is processed via a processor separate from the receiving unit 64. The processor 64 then analyzes the information, and the analysis (e.g., grades, additional assessment items, reports, sample examinations, etc.) is reported, for example, via the reporting unit 646 to the user (e.g., student, proctor, parent, school, surveyor, etc.).

Since the individual responses and the collection of responses are stored, when indicated by the user as being his/her final response, in the input device 62 and/or the receiving unit 64, the information that is analyzed and, thus, reported is reliable.

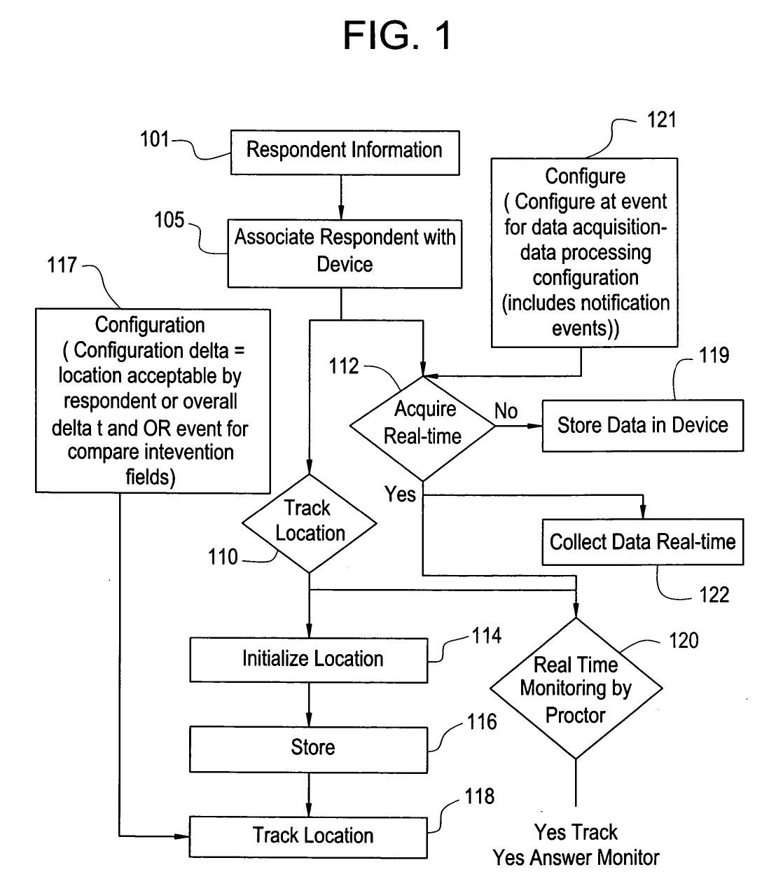

According to the method of gathering an assessment or survey response collection, as illustrated in FIG. 1, user identification information, such as, for example, student identification (ID), student name, student classroom, a unique identifier, previous performance information, address, phone number, ethnicity, etc., is provided in step 101. The user identification information can be used for tracking purposes, as will be described in detail below. The user identification information is then associated with a particular input device 62 (step 105). For example, prior to distribution, the user identification information is entered into the input device 62. The user identification information can be entered into the input device 62 via input keys 624 or a user interface (e.g., computer), scanned, transmitted or downloaded (e.g., using a software program) to the input device 62, etc.

The location of the input device 62 can be tracked during the administration of an assessment or survey in steps 110-118. For example, if the input device 62 exceeds a predetermined threshold (e.g., caused by a movement of a significant distance), the input device 62 can notify/alert the appropriate person (e.g., proctor) of such movement, i.e., beep via alarm 626 (FIG. 6), record such movement in memory 622, transmit information regarding the movement to the receiving unit 64, etc. The predetermined threshold can be set by the proctor or the system according to the present invention.

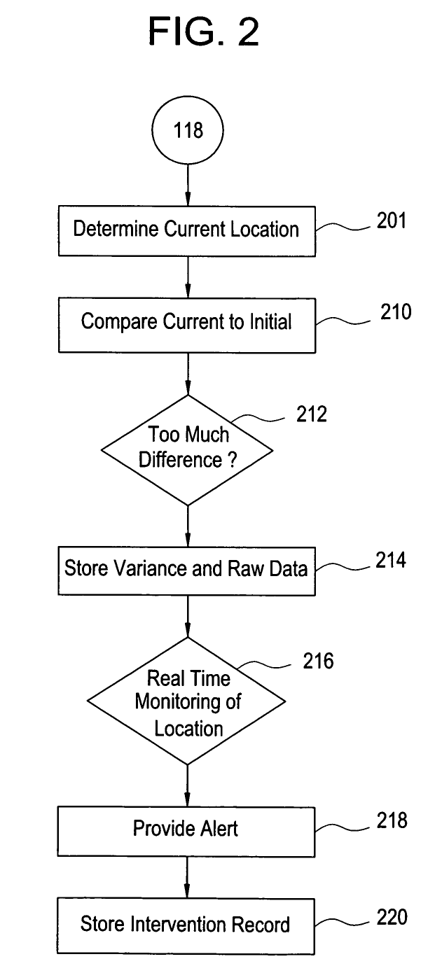

Referring to FIG. 1, an initial evaluation of the location of the input devices 62, using the location process of FIG. 2 (which will be described in greater detail below), is triggered at step 114. For example, once all input devices 62 have been passed out and the users are in their respective testing locations, the proctor can press a button on his/her user interface (e.g., computer) and will proceed to step 201. Accordingly, a triangulation of signals or other location finding process will occur such that the system can identify where each signal is being transmitted. Next, the system stores the information obtained during the location finding at step 116, and continues to track the location of the input devices 62 during testing in step 118.

In step 117, the current location is compared to the initialized location to ensure that each input device 62 has not moved a predetermined distance during the administration of the assessment or survey.

If the location of the input device 62 is not tracked during testing, the method proceeds to step 112. It is determined, in step 112, whether or not the information (e.g., test responses) will be acquired in real-time during the administration of the assessment or survey. If the information is not collected in real-time, the information is stored in the input device 62 (step 119). If the information is acquired in real-time, a data processing configuration occurs to prepare the system to accept and track the information including the notification events (step 121).

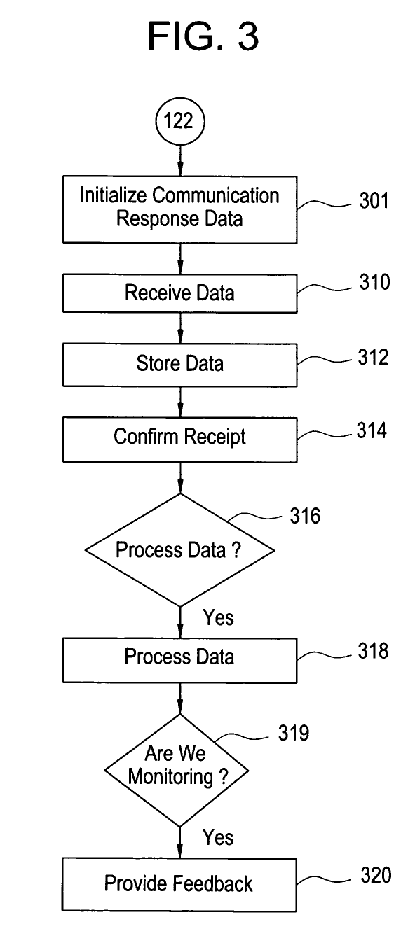

The information that will be transmitted in real-time during the administration of the assessment or survey can be tracked and monitored in step 120. Next, the information is collected using the collection process of FIG. 3, which will be described in greater detail below.

FIG. 2 shows a process that illustrates the basic flow of events that occur when a current location of the input device 62 is determined. Referring to FIG. 2, in step 201, and in the exemplary embodiment of the present invention, a triangulation of radio frequencies is used to determine the location of the input devices 62. It will be appreciated by those skilled in the art that other means may be implemented in locating the input devices 62, such as, for example, determining a signal at a single receiver (e.g., via a global positioning system or GPS), using an inertial compass to determine the initial orientation and speed, etc. Once one or more baseline measurements are taken in step 201, the current location is compared with the baseline location(s) in step 210.

In step 212, if a predetermined threshold for storing variance information is exceeded in step 210, the raw information used to determine the variance and the threshold limits (e.g., information regarding the threshold(s) that was exceeded) are stored (step 214). The predetermined threshold can be set by the user or the system, conditional baselines can be set by the user, and circumstances of the administration of the assessment or survey can be used to determine the thresholds based on circumstance configurations. These values can be stored in a central database, the input device 62, etc.

Configuration information provided either through user explicit configuration, system detection, or some other method of monitoring the location of the input device 62 in real-time is utilized in step 216. The user is warned in step 218 that he/she has moved a significant distance, i.e., exceeded a predetermined threshold. For example, a dialogue box warning message is displayed on display 628 of the input device 62. The warning message can contain the location information, the exceeded thresholds, suggested measurements or thresholds, etc. The user has an option to remedy his/her violation. In step 220, a record of the violation (or intervention) is stored in the memory of the input device 62 and/or receiving unit 64. In the case of a violation (or intervention), the record can contain multiple types of data, including, but not limited to, free text, binary files, such as audio, video, images, forms, signatures, biometric data, intervention codes, pre-selected lists and date/time stamps.

FIG. 3 shows a process that illustrates the basic flow of events that occur when information is collected during real-time. As illustrated in FIG. 3, the input device 62 communicates with the receiving unit 64 and initiates the real-time gathering of the responses (step 301). Information from (or stored in memory 622 of) the input device 62 is transmitted to the receiving unit 64 (step 310) and stored in the memory 642 of the receiving unit 64 (step 312). In the exemplary embodiment of the present invention, the receiving unit 64 confirms receipt of the information and transmits a confirmation to the input device 62 (step 314). In an alternate embodiment, the information can be simply transmitted to the receiving unit 64 without confirmation.

In step 316, it is determined whether or not the information gathered in real-time and transmitted to the receiving unit 64 is processed via processor 644. In the exemplary embodiment of the present invention, if the information is processed (step 318), the responses are analyzed (i.e., graded, scored, reported, performance, etc.) upon receipt. In an alternate embodiment, all the responses are collected and after the assessment or survey is completed, the responses are then analyzed. The analysis can include a comparison of transmitted individual responses against the collection file for purposes of validation. If a discrepancy is detected (e.g., because of tampering, transmission errors, corrupt files, etc.), the system can apply predetermined rules to resolve the discrepancy (e.g., by favoring the response in the collection file, or favoring a response with a more recent date stamp, etc.). The system can be configured to perform such a validation at predetermined times during the assessment, after a predetermined number of responses are transmitted, after a predetermined group of assessment items have been completed, or after all assessment items have been completed. If a discrepancy exists, the system can be configured to notify the user and/or the administrator. The system can also be configured to store a copy of the collection file within the receiving unit memory for safekeeping in the event a discrepancy is detected.

In step 319, if the information that is transmitted in real-time during the administration of the assessment or survey is tracked and monitored in step 120, then feedback, such as a user is not responding, responding too rapidly, responding all wrong, etc., can be provided to the proctor in step 320.

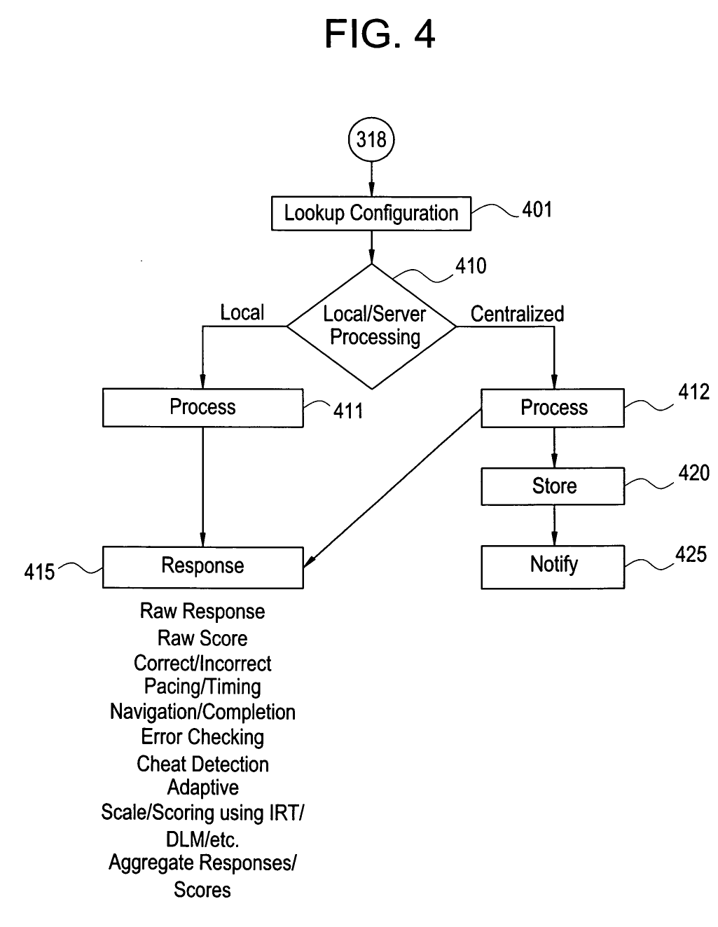

FIG. 4 is a flow chart illustrating the basic flow of events that occur during a look-up process. Referring to FIG. 4, in step 401, the process type configurations that have been made earlier are retrieved and interpreted to drive and determine the types of processing to be executed. In step 410, the information is divided depending on the configuration, and multiple levels of processing (e.g., local or customized) is allowed. For example, local processing is performed at the input device 62 and classroom level (steps 411-415), and server processing can be done at the school, district, and other centralized servers (steps 412-425). The processing is divided appropriately in the proper location depending on the configuration. Types of processing at the local level include driving error checking, identifying correct/incorrect responses, determining raw score, calculating pacing/timing, evaluating navigation/completeness, cheat detection, adaptive scale/scoring, determining aggregate responses and scores, and determining the progress of students and other types of data that consolidate the user responses or classroom level.

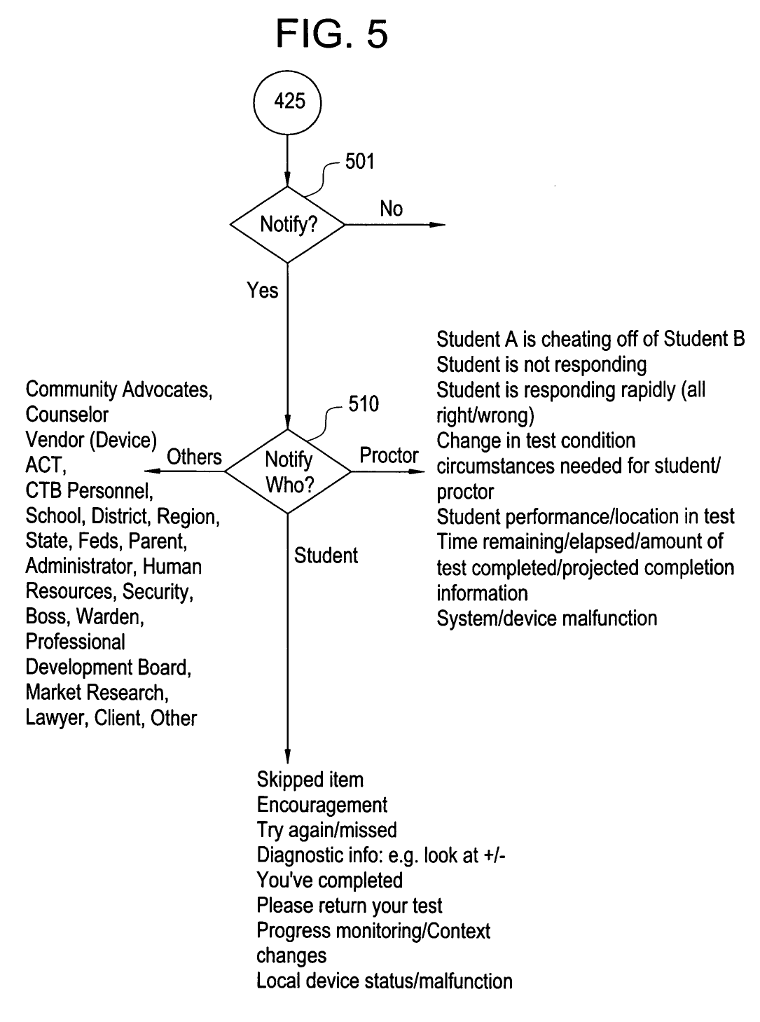

FIG. 5 shows a process that illustrates the basic flow of events that occur when a user is notified. As shown in FIG. 5, it is determined whether or not a “notify” process will be initiated in step 501. If “no,” then the process ends. If “yes,” then the identification of the entity (e.g., student, proctor, other, etc.) is determined in step 510. “Other” can include, for example, community advocates, councilor, vendor, ACT, publisher (e.g., CTB) personnel, school, district, region, state, federal, parent, administrator, human resources, security, boss, warden, professional development board, market research, lawyer, client, department stores, etc., based on the nature of the assessment or survey and the purpose of the notification.

If the entity is a “student,” he/she is notified of, for example, skipped or missed items, progress, context changes, local device status/malfunctions, diagnostic information, etc., and notified of other messages, such as, for example, encouragement, try again/missed, you have completed the assessment or survey, please return your test, etc. If the entity is a “proctor,” he/she is notified if, for example, a student is cheating (i.e., Student A is cheating off of Student B), not responding or responding rapidly (i.e., all right/wrong responses), a change in an assessment/survey condition circumstances needed for a student/proctor, student performance/location on assessment/survey, time remaining/elapsed, amount of test completed, projected completion information, system/device malfunction, etc.

The system and method for assessment or survey response collection using a digitally recording user input device according to the present invention overcome the deficiencies of the prior art. User identification information is associated with an input device, which is used during administration of an assessment or survey. Response information for each item of the assessment or survey, and a collection of responses (e.g., all the responses to the assessment/survey items contained in the assessment/survey) are saved in the input device, and transmitted to a receiving unit. The response information that is associated with a user is processed and analyzed via the receiving unit or a processor, such that reliable information is reported to the user, student, proctor, or other entity.

The input device of the present invention is a remote, portable and affordable tool for collecting responses to assessment items, whereby “assessment” is meant a test, an exam, a quiz, a survey or any other type of information or data gathering tool.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

While a preferred embodiment of the present invention has been described above, it should be understood that it has been presented by way of example only, and not limitation. Thus, the breadth and scope of the present invention should not be limited by the above described exemplary embodiment.

For example, one or both of the input device and the receiving unit can be configured for communication over an intranet or the Internet to facilitate online testing whereby a set of responses to assessment or survey items are communicated directly to a centralized server, e.g. at the content publisher, for scoring. Some of the benefits of online testing are that it eases shipping and tracking logistics by reducing or eliminating the printed materials required to administer items. Online testing with the input device and system according to the present invention also eliminates the need for manual scanning, with scoring beginning upon submission of responses, thereby further motivating students and easing the burden on classroom teachers.

If the input unit is configured to allow entry of written responses in the form of essays, e.g., via a keyboard, stylus or voice recognition system, the system of the present invention can make use of automated essay scoring such as, e.g., the IntelliMetric automated essay scoring system developed by Vantage Learning, to provide early access to writing reports in a cost effective manner. Similarly, if the input unit is configured to allow entry of constructed responses such as graphing, circling, crossing-out, annotating, connecting, matching, erasing, modifying or otherwise marking up portions of presented assessment or survey materials, or producing short answers, the system can make use of an automated constrained constructed response assessment system such as that described in commonly owned Provisional Patent Application Ser. No. 60/685,082, filed on May 27, 2005, the disclosure of which is hereby incorporated by reference.

The system of the present invention can also be configured to automatically report assessment results to educators and parents via a web-based parent reporting service. The benefits of web-based reporting for parents are early access to each child's reports, the ability to review results from previous years, and familiar website navigation tools which are particularly advantageous for multi-lingual parents. For educators, the web-based reporting service offers faster, secure delivery of report data, actionable results for decision making and planning, aggregate/disaggregate reporting at the class, school and district levels, and optional inclusion of other assessment data, such as Reading First or NRT.

It will also be appreciated that the reductions in cost and turn around time for assessment facilitate integration of formative and summative tests so as to allow multiple scaled tests which assess standards at designated intervals. This also allows early administration of constructed response items and decreases testing time at the end of the year for even faster reporting. If desired, all test scores can be aggregated for final accountability measure.

Obviously, numerous modifications and variations of the present invention are possible in light of the above teachings. It is therefore to be understood that the invention may be practiced otherwise than as specifically described herein.

What is claimed is:

1. A system for collection of responses to items of an assessment, comprising:
an input device having a first memory for storing an individual response to an item of an assessment and a collection file containing all the responses to the items contained in the assessment; and
a receiving unit having a second memory;
wherein said input device is configured to transmit individual responses to said receiving unit;
wherein said receiving unit is configured to store said transmitted individual responses in said second memory; and
wherein said receiving unit is further configured to validate said transmitted individual responses by performing a comparison with said collection file.

2. The system of claim 1, wherein said input device is configured to transmit said individual responses immediately after a user indicates the completion of the assessment item.

3. The system of claim 1, wherein said input device is configured to transmit said individual responses and said collection file after the completion of the assessment.

4. The system of claim 1, wherein said input device is configured to transmit stored responses to said receiving unit at predetermined times during administration of the assessment.

5. The system of claim 1, wherein said input device is configured to transmit a response to said receiving unit after a predetermined period of user inactivity during administration of the assessment.

6. The system of claim 1, wherein said input device is configured to transmit responses to said receiving unit upon completion of a predetermined group of assessment items.

7. The system of claim 1, wherein said receiving unit further includes a processor configured to analyze individual responses transmitted from said input device.

8. The system of claim 7, wherein said receiving unit further includes a reporting unit configured to report results of the analyzed responses.

9. The system of claim 1, wherein said receiving unit is configured to transmit a notification during administration of the assessment.

10. The system of claim 9, wherein said receiving unit is configured to transmit said notification to said input device and wherein said notification contains at least one message selected from the group consisting of notification that the user has skipped an item, encouragement, notification that the user responded incorrectly to an item, notification to try an item again, diagnostic information, notification that assessment completed, request for user to return assessment, progress monitoring/context change notice, and notification of system malfunction.

11. The system of claim 9, wherein said receiving unit is configured to transmit said notification to an administrator and wherein said notification contains at least one message selected from the group consisting of notification that one user is cheating off another user, notification that a user is not responding, notification that a user is responding rapidly, notification that a user is answering all assessment items right or wrong, notification of a change in test condition, notification of circumstances needed for user, notification of student performance/location in assessment, notification of time remaining/elapsed, notification that test completed/projected completion, and notification of system malfunction.

12. The system of claim 9, wherein said receiving unit is configured to transmit said notification in the event the comparison indicates a discrepancy between transmitted individual responses and said collection file.

13. The system of claim 12, wherein said receiving unit is configured to send said notification to said input device.

14. The system of claim 12, wherein said receiving unit is configured to send said notification to an administrator.

15. The system of claim 1, wherein said receiving unit is configured to resolve discrepancies identified by said comparison through application of a predetermined rule.

16. The system of claim 15, wherein said predetermined rule calls for said discrepancy to be resolved in favor of said collection file.

17. The system of claim 15, wherein said predetermined rule calls for said discrepancy to be resolved by comparison of date stamps.

18. The system of claim 1, wherein said comparison includes checking whether the last of the individual responses matches the last of the responses in said collection file.

19. The system of claim 1, wherein said receiving device is configured to store a copy of said collection file in said second memory in the event the comparison indicates a discrepancy between transmitted individual responses and said collection file.

20. A method of gathering responses to items of an assessment using a digitally recording input device, said method comprising the steps of:
using the input device to enter individual responses to items of an assessment;
storing within the input device each individual response and a collection file containing all the responses to the items contained in the assessment;
transmitting the individual responses to a receiving unit remote from the input device; and
validating the transmitted individual responses by performing a comparison with the collection file.

21. The method of claim 20, wherein said step of transmitting an individual response occurs before the storing step.

22. The method of claim 20, wherein said step of transmitting an individual response occurs after the storing step.

23. The method of claim 20, wherein said step of transmitting the responses occurs at predetermined times during the assessment.

24. The method of claim 20, wherein said step of transmitting the responses occurs after a predetermined period of inactivity.

25. The method of claim 20, wherein said step of transmitting the responses occurs after a predetermined group of assessment items have been answered.

26. The method of claim 20, wherein said validating step includes comparing a last transmitted individual response with a last response in said collection file.

27. The method of claim 20, wherein said validating step is performed at predetermined times during the assessment.

28. The method of claim 20, wherein said validating step is performed after a predetermined group of assessment items have been answered.

29. The method of claim 20, wherein said validating step is performed after completion of the assessment.

30. The method of claim 20, further comprising the step of resolving a discrepancy between transmitted individual responses and the collection file.

31. The method of claim 30, wherein said resolving step includes applying a predetermined rule.

32. The method of claim 20, further comprising the step of storing within the receiving unit a copy of the collection file in the event said validating step indicates a discrepancy between transmitted individual responses and the collection file.

33. A method of collecting responses to items of an assessment using a digitally recording input device, comprising:
associating an input device with a user;
determining an initial location of the input device;
collecting responses to items of an assessment using the input device;
transmitting the responses from the input device to a receiving unit for analysis;
monitoring the current location of the input device during the step of collecting responses; and
determining whether the input device has moved more than a predetermined acceptable distance based on the initial and current positions.

34. The method of claim 33, further comprising the step of alerting a proctor administering the assessment if it is determined that the input device has moved more than the predetermined acceptable distance.

35. The method of claim 33, further comprising the step of alerting the user if it is determined that the input device has moved more than the predetermined acceptable distance.

36. The method of claim 33, wherein the input device includes an audible device and said step of alerting the user includes sounding an alarm using the audible device.

37. The method of claim 33, further comprising the step of recording that the input device has been moved if it is determined that the input device has moved more than a predetermined acceptable distance.

38. The method of claim 33, further comprising the steps of analyzing the responses and generating a report containing an indication that the input device was moved.

39. The method of claim 33, wherein the predetermined acceptable distance is set by a proctor based on conditions at the site where the assessment is conducted.

40. The method of claim 33, wherein said step of monitoring the location of the input device is performed by the input device, and further comprising the step of transmitting the current location to a receiving unit remote from the input device.

41. The method of claim 33, wherein said step of monitoring the location of the input device is performed by a remote receiving unit.

42. The method of claim 33, wherein said steps of determining an initial location and monitoring a current location include the step of triangulating radio frequency signals.

43. An input device for remote collection of responses to items of an assessment calling for specific response types, the items each being associated with a unique item identifier, said device comprising:
a user interface configured to facilitate entry of the specific response types called for by the assessment items;
a display unit capable of displaying an item identifier and the specific response type associated with an assessment item associated with the item identifier;
a memory device;
a wireless transmitter;
a locating device; and
a processor programmed to cause responses to assessment items to be stored in said memory device in association with corresponding item identifiers, to be displayed to a user by the display unit, and to be transmitted to a remote receiver by the wireless transmitter;
wherein said processor is further programmed to obtain an initial location for the input device and to monitor the input device location thereafter using the locating device.

44. The input device of claim 43, wherein said processor is further programmed to notify a remote receiver if the input device is moved more than a predetermined distance from the initial location.

45. The input device of claim 44, further comprising an alarm, wherein the processor is programmed to notify the user using the alarm if the device is moved more than a predetermined distance from the initial location.
